(19) United States
(12) Patent Application Publication
(10) Pub. No.: US 2006/0015602 A1
(43) Pub. Date: Jan. 19, 2006

(54) Control equipment management system

(75) Inventors: Atsushi Inoue, Kanagawa-ken (JP); Masahiro Ishiyama, Tokyo (JP); Kazuya Kubo, Tokyo (JP); Nobuo Okabe, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: Kabushiki Kaisha Toshiba, Tokyo (JP); Yokogawa Electric Corporation, Tokyo (JP)

(21) Appl. No.: 11/138,450

(22) Filed: May 27, 2005

(30) Foreign Application Priority Data
May 31, 2004 (JP) 2004/161713

(51) Int. Cl. G06F 15/173

(52) U.S. Cl. 709/223

(57) ABSTRACT

A control equipment management system integrates and displays data transmitted from a plurality of control equipment units provided at devices to be monitored and controlled, can flexibly modify the form of display, and can employ existing equipment as control equipment. Control equipment units 30a to 30n monitor the status of, and control the operation of, devices to be monitored and controlled. Remote computer 10 collects data output from control equipment units 30a to 30n via network N, and outputs control signals to the control equipment units 30a to 30n. Display command server 20 connected to network N stores or generates display commands determining the form of display of data output from each of control equipment units 30a to 30n. Remote computer 10 displays data collected from each of Control equipment units 30a to 30n according to the display form of display commands obtained from the display command server 20.

### BACKGROUND OF THE INVENTION

1. Field of the Invention

This invention relates to a control equipment management system, which manages various control equipments that are used to monitor and control the operating states of devices and similar to be monitored and controlled.

Priority is claimed on Japanese Patent Application No. 2004-161713, filed May 31, 2004, the contents of which are incorporated herein by reference.

2. Description of Related Art

A variety of control equipments are installed for the different devices which are provided in factories and similar and requiring monitoring and control. By means of such control equipment, the operation of various devices is controlled. In particular, the larger the scale of the factory is, the greater the number of devices for monitoring becomes, and the greater the number of parameters to be monitored becomes. Therefore, the tendency to use control equipment for controlling increases. Such control equipments are connected to a remote computer via network or similar, transmits measurement data such as the temperature, flow rate, pressure, or similar either within or outside of devices, as well as image data capturing the external appearance of devices and similar to the remote computer via network, and therewith, controls devices based on control data transmitted from the remote computer via network.

When controlled equipments transmit data to a remote computer, transmission is in formats determined in advance for each data type, and the remote computer receives data which is transmitted from the various control equipments in the formats determined in advance and displays the contents on a display monitor or other display device. When for example, a command from an operator is input, the remote computer transmits control data indicating the contents of the command to the control equipment specified by the operator via network, and based on the control data, the control equipment controls device operation. A control equipment management system for monitoring and controlling of devices to be monitored and controlled is configured using the above-described control equipment and remote computer. Details of conventional control equipment management systems are for example given in U.S. Pat. No. 5,805,442.

However, in the above-described conventional control equipment management system, as explained above, the formats of data transmitted by various control equipments to the remote computer are determined in advance, but apart from the formats of the data itself, it has been necessary to define in advance a format indicating the form of display, and to transmit form data indicating this format to the remote computer. This is because the form for displaying data content is different, and therefore, by transmitting display form data together with the data to the remote computer, data can be displayed on the remote computer in a display form which is appropriate to the data, in the form specified by the control equipment, without concerning differences in the display form of different data provided by specific equipment.

However, when attempting to apply conventional equipment which is providing a LON (Local Operating Network) device (registered trademark of Echelon Corporation), field (registered trademark of the Fieldbus Foundation) bus device or similar, to the above-described control equipment management system, there is the problem that measurement data and other data is output from the control equipment, but display form data indicating the display forms on the remote computer is not output. Further, a similar problem arises when equipments which do not provides resources that are necessary for storing such display form data is to be applied to the above-described control equipment management system. Here, LON is an intelligent distributed control network applying a neuron chip having input/output functions, network communication functions or similar, and a field bus is a standard for using digital communication to exchange signals between control equipment with various types of equipment (measurement instruments, handling devices, or similar) operating in a factory or similar.

By using the above-described display form data in a conventional control equipment management system, the contents of data which is transmitted from individual control equipment units can be displayed in an appropriate form on the remote computer, but data which is transmitted from different control equipment units cannot be integrated and displayed. Because different formats are defined for each control equipment unit, in order to display data from a plurality of control equipment units, it is for example necessary to open separate windows for display, and therefore, there is the problem that the displayed content becomes confused.

Further, because data which is transmitted from each control equipment unit and the format indicating the display form are associated in advance in a fixed manner, when it is required to change the data display form on the remote computer, no solution can be applied on the remote computer side. In order to change the data display form on the remote computer, the format indicating the display form defined for each control equipment unit must be changed, and therefore, there is the problem that flexibility is lacking.

Current invention has been made in the light of above described circumstances, and has as an object to provide a control equipment management system which is capable of integrating and displaying data transmitted from a plurality of control equipment units provided for monitoring and control, which can flexibly change the form of display, and which can be applied as control equipment to existing equipment provided for monitoring and control.

### SUMMARY OF THE INVENTION

The first aspect of current invention is a control equipment management system, which manages control equipment units (30a to 30n) which perform at least one among monitoring and control of devices to be monitored or controlled, comprising: a remote computer (10) which is connected to network (N), collects data from said control equipment units via the network, and comprises a display device (12) which displays the collected data; and, a display command server (20) which is connected to the network and sends display commands to said remote computer, wherein the display commands define the form of display when the display device provided to the remote computer displays the collected data from said control equipment units.

According to this invention, data from control equipment is transmitted to the remote computer via network, and in addition, display commands, defining the display form at the time when displaying data which is output from control equipment, on the display device which is provided in the remote computer, are transmitted to the remote computer from the display command server via network, and data which is obtained from control equipment is displayed on the display device of the remote computer in a display form defined by a display command.

The second aspect of the invention is the control equipment management system which is described above, wherein the display command server dynamically generates the display commands and sends the display commands to the remote computer.

According to this invention, display commands are generated dynamically by the display command server.

The third aspect of this invention is the control equipment management system which is described above, wherein the display command server sends the display commands to the remote computer and the display commands define integrating and displaying of the collected data from a plurality of the control equipment units on said display device.

The fourth aspect of this invention is the control equipment management system which is described above, comprising a control equipment directory server (40) which is connected to the network and sends information to the remote computer, wherein the information relates to the control equipment units which is connected to the network.

According to this invention, information relating to control equipment connected to the network is provided by the control equipment directory server to the remote computer.

The fifth aspect of this invention is the control equipment management system which is described above, wherein the control equipment directory server sends the information relating to the control equipment units to the remote computer, wherein the information of the control equipment units connected to the network, corresponds to search condition that is transmitted from the remote computer via the network.

According to this invention, search conditions are transmitted from the remote computer to the control equipment directory server in order to search for control equipment for management, and information relating to control equipment corresponding to the search conditions is sent to the remote computer by the control equipment directory server. The sixth aspect of this invention is the control equipment management system which is described above, wherein the display commands comprise data for showing the control equipment units as objects on the display device, and information relating to the attributes and status of the objects.

According to this invention, the control equipment is displayed as an object on the display device, according to data and information included in the display command.

In this invention, a display command server is provided which issues display commands, indicating the form of display of data output by control equipment, to the remote computer, so that data output from control equipment can be separated from data indicating the display form. Consequently there is the advantageous result that the display form of data displayed on the display device of the remote computer can be changed flexibly, simply by changing display commands. Further, because data output from control equipment is separated from data indicating the display form, there is the advantageous result that even existing equipment from which data indicating the display form cannot be obtained together with data can be used as the above-described control equipment.

In this invention, display commands are generated dynamically by the display command server, so that there is the advantageous result that flexible accommodation is possible, according to the control equipment connected to the network, or according to the commands of an operator operating the remote computer.

In this invention, with data output from control equipment separated from display commands determining the form of display thereof, the remote computer accepts display commands for integrating and displaying data collected from a plurality of control equipment units on the display device, so that there is the advantageous result that data obtained from the control equipment units can be integrated and displayed on the display device. At this time, data obtained from all of the plurality of control equipment units can be integrated and displayed, or data obtained from a portion of the plurality of control equipment units can be integrated and displayed.

In this invention, the remote computer is provided with information relating to the control equipment connected to the network, so that there is the advantageous result that even when changes occur in the control equipment connected to the network, flexible accommodation according to the changes is possible.

In this invention, information relating to control equipment corresponding to search conditions, used to search a control equipment directory server from the remote computer for control equipment to be managed, is provided to the remote computer by the control equipment directory server, so that there is the advantageous result that the management computer can grasp control equipment to be managed without sequentially accessing the control equipment units connected to the network, and can obtain information relating to the control equipment.

Further, in this invention control equipment units are displayed as objects on the display device, so that the operator operating the remote computer can easily recognize individual control equipment units from the objects displayed on the display device, and a plurality of control equipment units can be very easily integrated and displayed on the display device.

### BRIEF DESCRIPTION OF THE DRAWINGS

FIG. 1 is a block diagram showing in summary the configuration of the control equipment management system of the first embodiment of the invention;

FIG. 2 shows an example of the display on the remote computer based on a display command from the display command server 20;

FIG. 3 shows an example of the display of data, acquired from control equipment units 30a to 30n, on the remote computer 10;

FIG. 4 shows an example of attribute display for a pressure gauge object P1;

FIG. 5 shows an example of the control contents of a switch object SW; and,

FIG. 6 is a block diagram showing in summary the configuration of the control equipment management system of the second embodiment of the invention.

### DETAILED DESCRIPTION OF THE INVENTION

The control equipment management system of this invention is explained in detail, referring to the drawings.

### FIRST EMBODIMENT

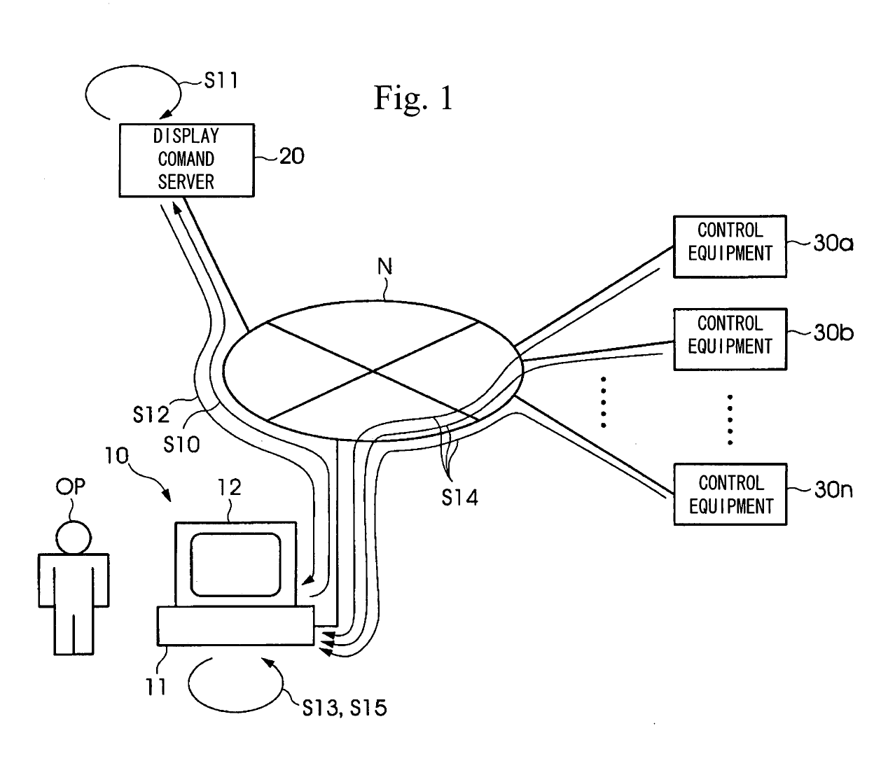

FIG. 1 is a block diagram showing in summary the configuration of the control equipment management system of the first embodiment of the invention. As shown in FIG. 1, the control equipment management system of this embodiment provides a remote computer 10 which is connected to network, a display command server 20, and control equipment units 30a to 30n (where n is a natural number).

The network N is for example a TCP/IP (Transmission Control Protocol/Internet Protocol) network, LON, or arbitrary network which is configured using a field bus, and is for example deployed within a factory. If a monitoring room which is provided for remote monitoring of devices in the factory is apart from the factory, the factory and the monitoring room are connected. In this embodiment, for simplicity of explanation, an example is explained in which all of the control equipment units 30a to 30n are installed in a single factory, but they can be distributed among a plurality of factories. When the control equipment management system manages a plurality of factories, each factory can be managed as a different site, or a single factory can be logically divided into a plurality of sites for management. In this aspect, for simplicity, an example is explained in which the factory in which the control equipment units 30a to 30n are installed is managed as a single site. The connection topology of the network N can be a bus, star, ring topology, and similar.

The remote computer 10 is for example provided in the above-described monitoring room, and is constructed from some parts including a computer main unit 11, display device 12 which is a CRT (Cathode Ray Tube), liquid crystal display, or other display device, and input device (not shown) such as a keyboard or mouse. The input device, not shown, is operated by an operator OP. The remote computer 10 has communication functions (for example, a network interface and protocol stack) for communication with the display command server 20 and the various types of equipments among the control equipment units 30a to 30n, connected to the network N.

Using these communication functions, the remote computer 10 periodically collects from the control equipment units 30a to 30n, via the network N, such data as temperature, flow rate, pressure, or other measurement data for the interior or exterior of devices for monitoring or control provided in the factory, image data capturing the external appearance of devices, and similar. Communication between the remote computer 10 and the control equipment units 30a to 30n can for example employ, as the communication protocol, SNMP (Simple Network Management Protocol).

The remote computer 10 communicates with the display command server 20 over the network N using the above-described communication functions, and acquires information (display commands) indicating the form of display on the display device 12 of the various data collected from the control equipment units 30a to 30n. Further, the remote computer 10 transmits over the network N, to the specified control equipment units 30a to 30n, control data indicating commands input by an operator through operation of an input device which is not shown. Communication between the remote computer 10 and the display command server 20 can for example employ, as the communication protocol, HTTP (Hypertext Transfer Protocol).

The display command server 20 provides a storage device which stores the above-described display commands or a program to dynamically generate display commands and a program to realize a WWW (World Wide Web) server, a CPU (Central Processing Unit) to execute the above programs and communication functions (for example, a network interface and protocol stack) for communication with the remote computer 10 connected to the network N. The storage device provides, for example, RAM (Random Access Memory) or another volatile internal storage device, FeRAM (ferroelectric memory) or MRAM (Magnetoresistive Random Access Memory) or another nonvolatile internal storage device, or a hard disk or other external storage device.

Above explained display commands include information relating to each of the control equipment units 30a to 30n, and information indicating the form of display of data output by each of the control equipment units 30a to 30n. The information relating to the control equipment units 30a to 30n contains the names and identifiers (IDs) of the control equipment units 30a to 30n, URLs (Uniform Resource Locators) for acquisition of data from each of the control equipment units 30a to 30n, communication protocols used by each of the control equipment units 30a to 30n, and similar.

Information indicating the form of display of data output from each of the control equipment units 30a to 30n includes data for display of each of the control equipment units 30a to 30n as objects on the display device 12 of the remote computer 10, the display positions of objects, and information relating to the attributes and status of the objects. Here, information relating to the attributes of an object is information added to the object such as the installed location, type of control equipment, and similar of the control equipment represented by the object, and information relating to the status of the object is information which indicates the operating status of the control equipment represented by the object. Information which is included in a display command and indicating the form of display of data output by the control equipment units 30a to 30n can be determined individually for each of the control equipment units 30a to 30n. Hence various display forms can be set for data output from control equipment units 30a to 30n of the same type.

Above explained display commands are written in HTML, JavaScript (a registered trademark), Java (a registered trademark), FLASH (a registered trademark), XML (Extensible Markup Language), and XMLT. The display commands or programs which generate display commands, stored on the display command server 20 can be modified or altered through operation of the remote computer 10 by the operator OP who operates the remote computer 10, and can be modified or altered by the operator who manages the display command server 20, through operation of the display command server 20.

The control equipment units 30a to 30n are installed on various devices to be monitored or controlled provided in the factory, and provide thermometers, flowmeters, pressure gauges, or other measurement instruments, or image capture devices. Signals measured or captured by these devices are temporarily stored in memory (for example, RAM) which is also provided and which also stores control data transmitted from the remote computer 10 via network N. Communication functions (for example, a network interface and protocol stack) are also provided for communication with the remote computer 10 connected to the network N.

These control equipment units 30a to 30n measure the external or internal temperature, flow, pressure, or similar of devices to be monitored or controlled using the above measurement devices, and temporarily store the measured results or captured images in the storage device. When a request for data collection is sent from the remote computer 10, the measurement data or captured-image data temporarily stored in the storage device is transmitted to the remote computer 10 via network N. Further, when control data is transmitted from the remote computer 10 via network N, the control data is stored in the storage device, and control is performed according to the contents of the control data. The format of data output from the control equipment units 30a to 30n is, for example, CSV (Comma Separated Value) or XML.

In addition to the above-described configuration, the remote computer 10, display command server 20, and control equipment units 30a to 30n are equipped with programs for authentication and encryption, in the interest of ensuring security. In the event of communication among this equipment, authentication is processed to confirm whether or not the target equipment is an authorized equipment unit. Data for transmission is then encrypted and transmitted to equipment which has been confirmed to be authorized.

Next, operation of the control equipment management system of the first embodiment of current invention, with the above-described configuration, is explained. First, an operator operates an input device which is not shown and which is provided at the remote computer 10, to input an URL to specify the factory (site) for management. Specifically, the operator starts for example a viewing program called a browser, and inputs the above-described URL into an URL address input area of the browser. When the URL is input, the remote computer 10 issues a request for transmission of a display command to the display command server 20 over the network N (step S10). Upon receiving this transmission request, the display command server 20 generates a display command according to a program stored in the storage device (step S11).

A display command which is generated in this manner, describes information of displaying on the display device 12 of the remote computer 10 in the initial state (display instruction), information relating to the control equipment units 30a to 30n, data acquired from the control equipment units 30a to 30n, and information indicating the display form, and is written in HTML, JavaScript (a registered trademark), Java (a registered trademark), FLASH (a registered trademark), XML (Extensible Markup Language) or XMLT. Here, an example is explained in which the display command server 20 dynamically generates display commands, however, it can be possible that display commands which are stored in advance on the display command server 20, are transmitted to the remote computer 10 when a display command transmission request is sent from the remote computer 10.

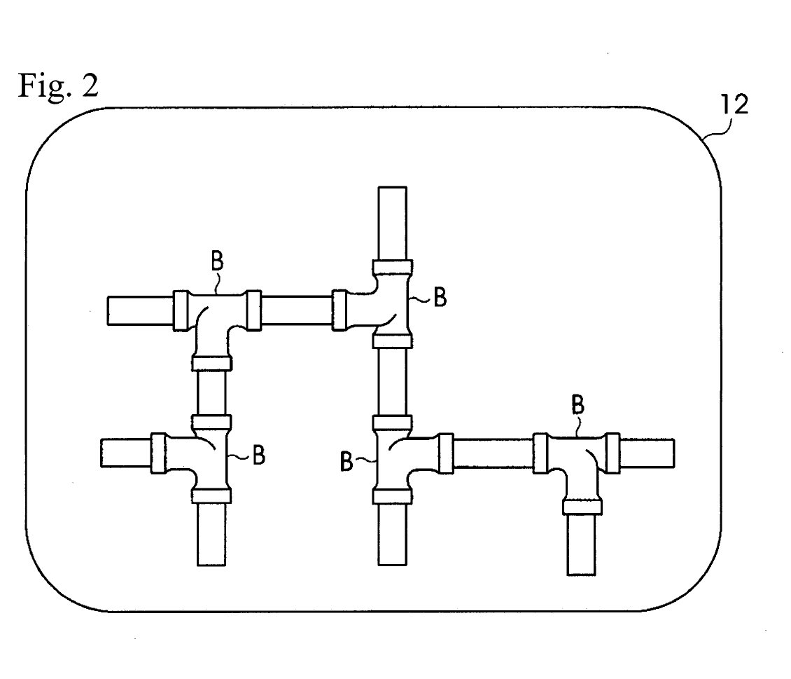

Upon completing generation of a display command, the display command server 20 transmits the generated display command to the remote computer 10 via network N (step S12). Upon receiving the display command transmitted from the display command server 20, the remote computer 10 analyzes the contents of the command, and based on the display instruction displays data on the display device 12 (step S13). FIG. 2 shows an example of the display on the remote computer 10 based on a display command from the display command server 20. As explained above, a browser is activated on the remote computer 10, and therefore, the actual display is shown on an area for display in the browser, however, to simplify the following explanation, the data is displayed on the display device 12.

In the example shown in FIG. 2, a flow path including a plurality of switching valves B and a plurality of pipes connected to the switching valves B is shown on the display device 12. In this embodiment, the flow path shown in FIG. 2 is a device to be monitored and controlled, and control equipment units 30a to 30n are for example mounted on the switching valves B.

When the above process is finished, the remote computer 10 outputs a data transmission request to the control equipment units 30a to 30n and acquires measurement data measured by, or image capture data captured by, the control equipment units 30a to 30n, based on information (names, thermometer or other types of devices, URLs, and similar) included in the display command (step S14). Upon acquiring data from the control equipment units 30a to 30n, the remote computer 10 displays the acquired data on the display device 12 in the display forms for each of the data items included in the display command, reflecting the acquired data in the display on the display device 12 (step S15).

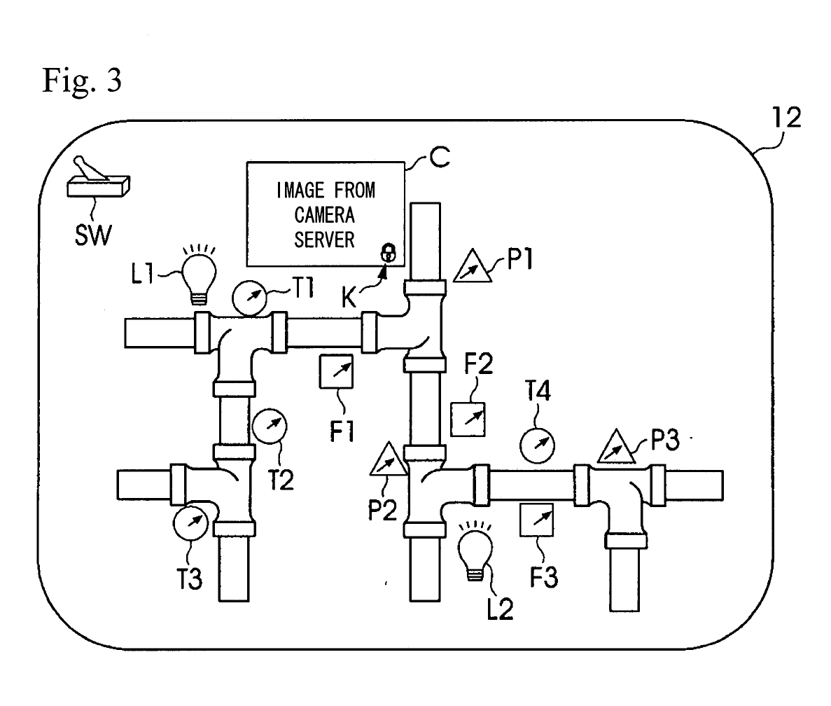

FIG. 3 shows an example of the display of data, acquired from control equipment units 30a to 30n, on the remote computer 10. In the example shown in FIG. 3, thermometer objects T1 to T4, pressure gauge objects P1 to P3, flowmeters F1 to F3, and light objects L1 and L2 are shown along the flow path of FIG. 2, and in addition, a camera object C and a switch object SW are displayed.

The thermometer objects T1 to T4, pressure gauge objects P1 to P3, and flowmeters F1 to F3 represent the thermometers, pressure gauges, and flowmeters which are provided at the control equipment units 30a to 30n. The light objects L1 and L2 and the camera object C represent illumination devices and an image capture device to respectively illuminate and capture the image of devices to be monitored and controlled, and the switch object SW represents a switch which controls operation of the devices represented by the thermometer objects T1 to T4, pressure gauge objects P1 to P3, flowmeter objects F1 to F3, light objects L1 and L2, and camera object C.

The remote computer 10 periodically outputs data transmission requests to each of the control equipment units 30a to 30n, and periodically collects the data (measurement data, image capture data, and similar) from the control equipment units 30a to 30n and displays the data contents according to display commands. For example, when the data which is collected, can be expressed as a number, the number is shown in the closure of each object in FIG. 3. Image capture data is displayed as the camera object C in FIG. 3.

With respect to communication with the equipment units connected to the network N, it is preferable that symbols which are indicating that security is maintained, be displayed in the closure of each object in a manner that an operator can easily determine whether or not security is being maintained. For instance, in the example shown in FIG. 3, an icon K representing a key which is indicating that security is maintained, is displayed for the camera object C.

As shown in FIG. 3, the remote computer 10 does not display the data obtained from the control equipment units 30a to 30n in individual windows, but integrates and displays the data. Specifically, all objects are displayed in a single display area of the browser. By means of this display, the display contents of the display device 12 are consolidated, so that the status of the devices to be monitored and controlled can be easily ascertained by an operator. The remote computer 10 periodically transmits display command transmission requests to the display command server 20, therefore, the remote computer 10 obtains display commands and the display according to the status of position of control equipments even can be shown even when control equipments have been added or removed.

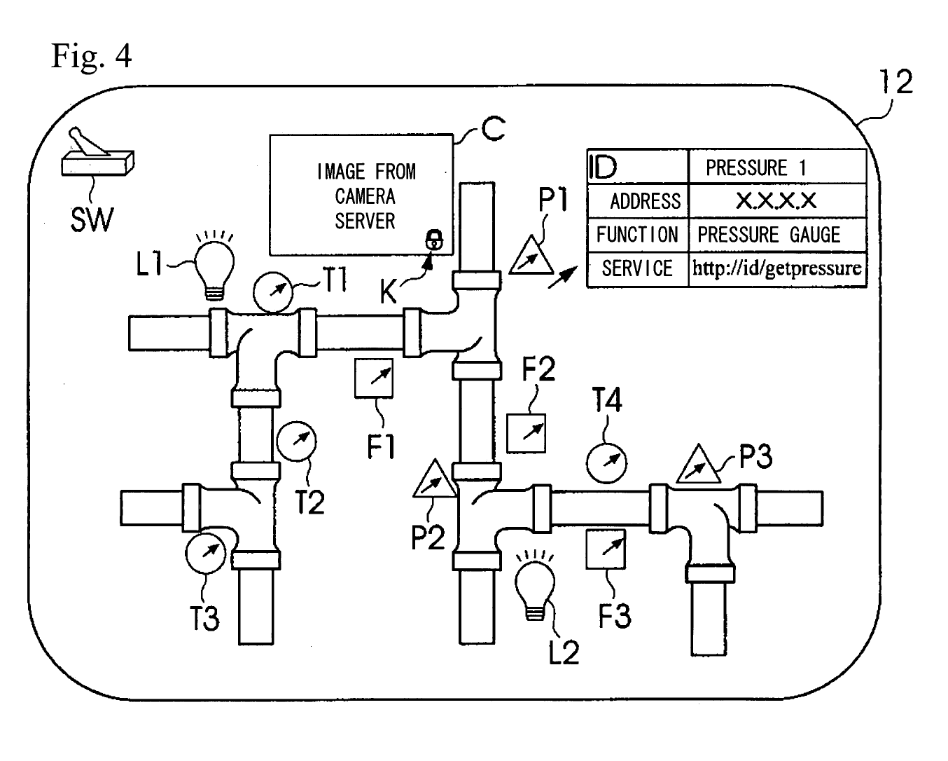

In a state in which the display shown in FIG. 3 is displayed on the display screen 12 of the remote computer 10, when an operator uses an input device which is not shown, to perform a specific operation on one of the objects displayed on the display screen 12, the attributes associated with the objects are displayed. For example, when a mouse, provided as one input device, is operated by an operator to move the mouse cursor, displayed on the display screen 12, to the display position of the pressure gauge object P1 and a right-click operation is performed, the contents shown in FIG. 4 are displayed.

FIG. 4 shows an example of attribute display for the pressure gauge object P1. In the example of FIG. 4, the identifier (ID) and URL address which are assigned to the pressure gauge represented by the pressure gauge object P1 are displayed as attributes of the pressure gauge object P1. Further, functions of the pressure gauge represented by the pressure gauge object P1, and the contents of services provided by the pressure gauge, are displayed. In the example of FIG. 4, “http://id/getpressure” is displayed as the method of service acquisition, and therefore, the remote computer 10 itself knows the method (protocol and method) for acquisition of pressure values of the pressure gauge and can acquire values either periodically or as single events and either based on an operator command or according to an instruction comprised by a display command.

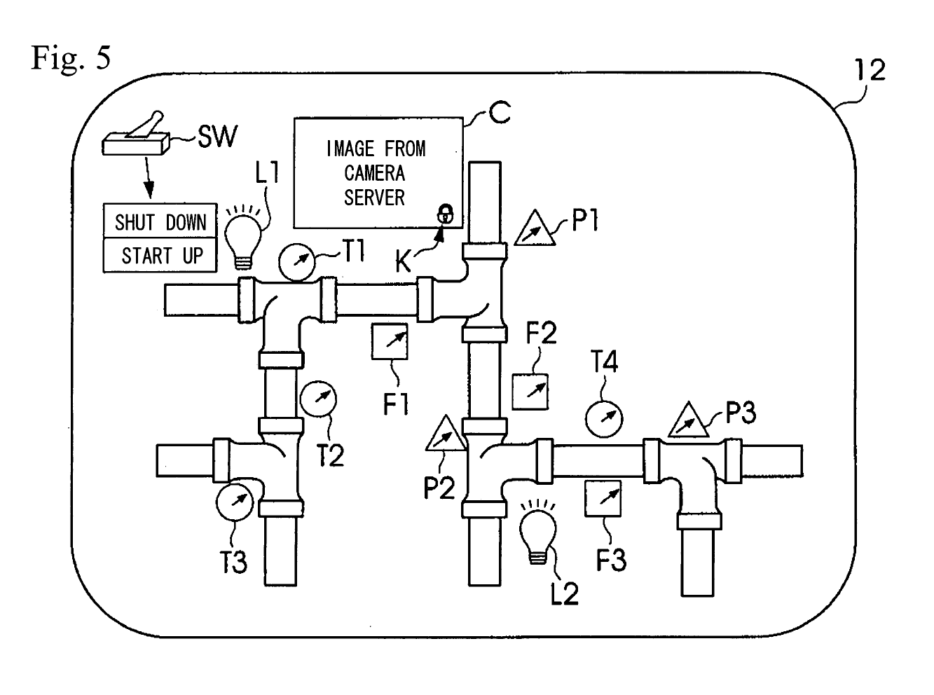

Further, an operator can also control the control equipment units 30a to 30n by operating an input device which is provided at the remote computer 10. For example, after an operator uses a mouse and selects one of the objects (for example, the light object L1) which is displayed on the display screen 12, when the user moves the mouse cursor to the display position of the switch object SW and clicks the right button, then the contents shown in FIG. 5 are displayed.

FIG. 5 shows an example of the control contents of the switch object SW. In the example shown in FIG. 5, as the control contents of the switch object SW, control to extinguish (shut down) and to light (start up) the illumination device represented by light object L1 is displayed. By selecting either of the control contents, control can be executed to light or extinguish the illumination device. It is preferable that the display of objects on the display device 12 be changed according to the status of the control equipment unit represented by the objects. For example, when the illumination device which is represented by the light object L1 is extinguished, the light object L1 is displayed with the brightness reduced, and when the illumination device is lit, the light object L1 is displayed with the brightness increased.

As explained above, the display commands or programs to generate display commands stored in the display command server 20 can be modified and changed by an operator through operation of the remote computer 10, so that the form of display on the remote computer 10 can be flexibly modified. A configuration is also possible in which an operator managing the display command server 20 performs operations on the display command server 20 to fix or modify display commands. Further, in order to set the display form for data output by the control equipment units 30a to 30n all at once on the display command server 20, existing equipment constructed from LON (Local Operating Network) devices, field bus devices or similar (equipments do not output display form data indicating the form of display of data but measurement data or other data) can also be used as control equipment units 30a to 30n. And because the control equipment units 30a to 30n are displayed as objects, it is easy to integrate the data from the plurality of control equipment units 30a to 30n for display on the display device 12.

### SECOND EMBODIMENT

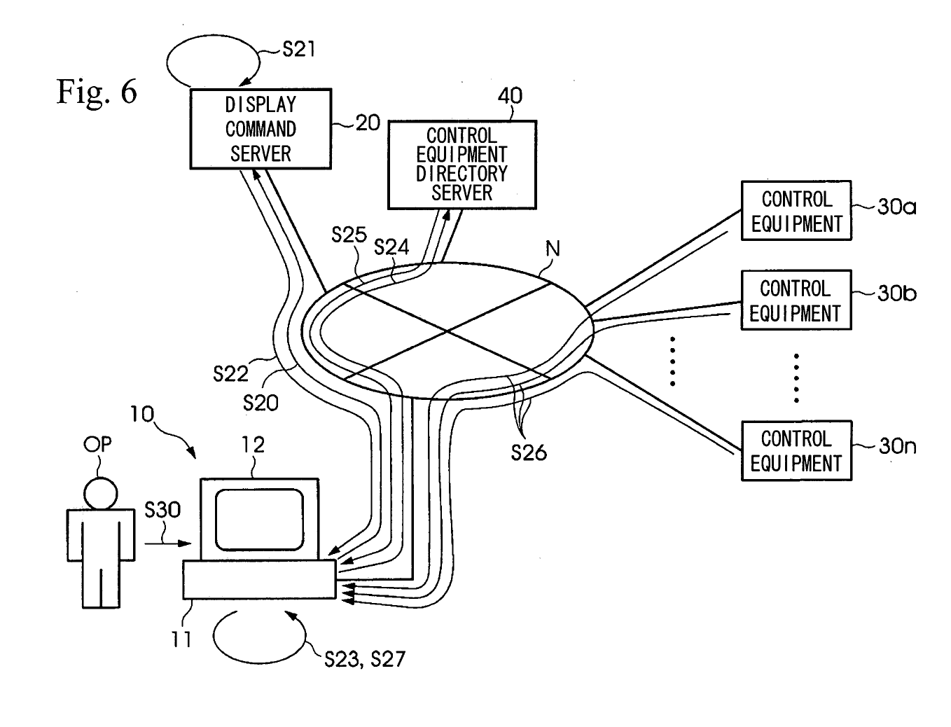

FIG. 6 is a block diagram showing in summary the configuration of the control equipment management system of the second embodiment of the current invention. The control equipment management system of the second embodiment of the current invention which is shown in FIG. 6 differs from the above-described control equipment management system of the first embodiment in providing a control equipment directory server 40.

The control equipment directory server 40 stores information relating to the control equipment units 30a to 30n, and provides a service for searching for added information (for example, an identifier (ID), service, or similar assigned to a specific control equipment unit based on attributes) for the control equipment units 30a to 30n. In the above-described first embodiment, this information was included in display commands stored on the display command server 20, however, in the present embodiment, this information is separated from display commands, and a server to supply this information is provided as a control equipment directory server 40. Further, the control equipment directory server 40 has functions to constantly ascertain the connection status of control equipment units 30a to 30n which are connected to the network N.

By separating information included in display commands relating to the control equipment units 30a to 30n from display commands, information relating to the form of display of data output (in this embodiment, only this information is called a display command) from each of the control equipment units 30a to 30n can be managed by the display command server 20, and information relating to the control equipment units 30a to 30n can be managed by the directory server 40. Hence even if there are frequent requests to change the form of display, or there are frequent changes to the control equipment units 30a to 30n, an operator who is managing each of the servers can handle immediately.

The control equipment directory server 40 is connected to the network N, and provides communication functions (for example, a network interface and protocol stack) to communicate with the remote computer 10, RAM or other memory to store the above program to supply search services and identifiers (IDs) assigned to each of the control equipment units 30a to 30n, and a CPU to execute the program. As the communication protocol in communication between the remote computer 10 and the control equipment directory server 40, for example, LDAP (Lightweight Directory Access Protocol) is used.

Next, the processing of the control equipment management system of the second embodiment of current invention, with the configuration described above, is explained. Similarly to the first embodiment, an operator starts a browser, and inputs the above URL into the URL address input area of the browser. When the URL is input, the remote computer 10 sends a display command transmission request to the display command server 20 via network N (step S20). Receiving this transmission request, the display command server 20 generates a display command according to a program stored in the storage device (step S21).

The display command which is generated in this manner includes information for displaying an initial state on the display device 12 of the remote computer 10 (display instruction), information indicating the form of display of data acquired from the control equipment units 30a to 30n, and information specifying the control equipment units to be directly managed by the remote compute r10 or conditions indicating the attributes of control equipment units to be directly managed by the remote computer 10. The display commands can be written in HTML, JavaScript (a registered trademark), Java (a registered trademark), FLASH (a registered trademark), XML (Extensible Markup Language), XMLT and similar. In this embodiment, the display command server 20 can also transmit display commands which are stored in advance to the remote computer 10, without generating display commands.

Display commands from the display command server 20 are transmitted to the remote computer 10 via network N (step S22). Upon receiving a display command transmitted form the display command server 20, the remote computer 10 analyzes the contents and displays data on the display device 12 based on the display instruction (step S23), and in addition transmits the attributes of the control equipment units 30a to 30n that are described in the display command, as search conditions, to the control equipment directory server 40 (step S24).

Upon receiving these search conditions, the control equipment directory server 40 searches control equipment units and attributes thereof matching the search conditions, based on the search conditions that are transmitted. Data for searching can be, for example, the type of a control equipment unit (thermometer, pressure gauge, or similar), the URLs of control equipment 30a to 30n for data acquisition, and formats (CVS, XML, or similar) for data obtained from the control equipment units 30a to 30n. When search results are obtained, the control equipment directory server 40 transmits the search results to the remote computer 10 via network N (step S25).

Upon receiving search results from the control equipment directory server 40, the remote computer 10 outputs a data transmission request to the control equipment units 30a to 30n based on information included in the received search results, and acquires measurement data measured by, or image capture data captured by, the control equipment units 30a to 30n (step S26). Upon receiving data from the control equipment units 30a to 30n, the remote computer 10 displays the data that are received on the display device 12 according to the display forms corresponding to each data item, included in the display commands, and reflects and shows the received data on the display device 12 (step S27).

According to the processes above, contents that are similar to the display contents of FIG. 3 are displayed, and when an operator operates an input device which is not shown and provided at the remote computer 10, the attributes of the control equipment units represented by each of the objects displayed on the display device 12 can be notified, and the control equipment units represented by each of the objects can be controlled.

As explained above, in this embodiment, information relating to the control equipment units 30a to 30n is separated from display commands and a control equipment directory server 40 to search for this information is provided, therefore, the control equipment units 30a to 30n can be managed all at once through the control equipment directory server 40. Hence, flexible maintenance and management of the control equipment units 30a to 30n is possible. Moreover, because the control equipment directory server 40 constantly obtains the status of connection to the network N of the control equipment units 30a to 30n, the actual connection status can be reflected in real-time in the display contents of the remote computer 10, even when there are changes to the connection states of the control equipment units 30a to 30n.

In the above embodiment, attributes of the control equipment units 30a to 30n are included in display commands which are obtained from the display command server 20, and these attributes are transmitted to the control equipment directory server 40 as search conditions. However, a configuration is also possible in which attributes are not included in display commands as search conditions, but an operator OP operates an input device of the remote computer 10 to input attributes of control equipment units 30a to 30n (step S30), and these attributes are transmitted to the control equipment directory server 40 as search conditions.

Processing of step S30 above can be performed at the time when a display command is received from the display command server 20 (step S22) and data is displayed on the display device 12 based on the display instruction which is included in the display command, or can be performed prior to the processing of step S20 to issue a display command transmission request to the display command server 20. By operating an input device to change as necessary the attributes as search conditions, an operator OP can view the status of numerous control equipment units from various viewpoints.

This invention is not limited to the above embodiment, but can be freely modified within the scope of the invention. For example, in the above forms of the invention, examples are explained of cases in which the status of various devices provided within a factory are monitored and controlled by managing control equipment. However, this invention is not limited to the status monitoring and control of devices provided within a factory, but can be applied to status monitoring and control of arbitrary devices to be monitored and controlled.

Further, in the above embodiment, the display command server 20 and control equipment units 30a to 30n are provided separately, however, a configuration can be adopted in which the functions of a display command server 20 are provided in any one of, or in a plurality of, the control equipment units 30a to 30n. In this case, it is desirable that control equipment units combining the functions of a display command server 20 be selected with ample memory or other storage resources and with a CPU with substantial processing capacity. Moreover, in the above embodiment, the control equipment units 30a to 30n acquire information relating to each of the devices as devices to be monitored and controlled, and also control the devices, however, this invention can also be applied in cases of management of control equipment having at least one among functions for acquisition of information relating to devices, and functions for control of devices.

Further, in the above embodiment, explanation is made with examples in which a WWW server is installed on the display command server 20, and a displaying program, called a browser, is installed on the remote computer 10. However, these are no more than examples, and it can be sufficient for the display command server 20 to include functions to supply the remote computer 10 with display commands, and for the remote computer 10 to include functions (for example, a dedicated client program) to access the display command server 20 and control equipment units 30a to 30n or directory server 40.

In the above second embodiment, an example is explained of a case in which the remote computer 10 accepts display commands from the display command server 20, and also accepts search results directly from the control equipment directory server 40. However, a configuration can be adopted in which the URLs of the control equipment directory server 40 are stored in the display command server 20, and when the remote computer 10 issues a display command transmission request to the display command server 20, the display command server 20 generates a display command, the remote computer 10 transmits search conditions to the display command server 20 and accepts search results, and the generated display commands and accepted search results are returned to the remote computer 10.

What is claimed is:

1. A control equipment management system, which manages control equipment units which perform monitoring or controlling of devices to be monitored or controlled, comprising:
a remote computer which is connected to a network, collects data from said control equipment units via the network, and comprises a display device which displays the collected data; and,
a display command server which is connected to the network and sends display commands to said remote computer, wherein the display commands define the form of display when the display device included in the remote computer displays the collected data from said control equipment units.

2. The control equipment management system according to claim 1, wherein the display command server dynamically generates the display commands and sends the display commands to the remote computer.

3. The control equipment management system according to claim 1, wherein the display command server sends the display commands to the remote computer and the display commands define integrating and displaying of the collected data from a plurality of the control equipment units on said display device.

4. The control equipment management system according to claim 1, comprising a control equipment directory server which is connected to the network and sends information to the remote computer, wherein the information relates to the control equipment units which is connected to the network.

5. The control equipment management system according to claim 4, wherein the control equipment directory server sends the information relating to the control equipment units to the remote computer, wherein the information of the control equipment units connected to the network, corresponds to search condition that is transmitted from the remote computer via the network.

6. The control equipment management system according to claim 1, wherein the display commands comprise:
data for indicating the control equipment units as objects on the display device; and
information relating to the attributes and status of the objects.
